(19) United States
(12) Patent Application Publication
(10) Pub. No.: US 2005/0007647 A1
(43) Pub. Date: Jan. 13, 2005

(54) Opto-electronic device with an integrated light deflector and wavelength tunable external cavity laser using the same

(76) Inventors: Kwang Ryong Oh, Daejon-Shi (KR); Kang Ho Kim, Daejon-Shi (KR); Oh Kee Kwon, Anyang-Shi (KR); Jong Hoi Kim, Daejon-Shi (KR); Hyun Soo Kim, Daejon-Shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/747,933

(22) Filed: Dec. 29, 2003

(30) Foreign Application Priority Data
Jul. 12, 2003 (KR) 2003-47635

(51) Int. Cl. G02B 26/00

(52) U.S. Cl. 359/290

(57) ABSTRACT

The present invention provides an opto-electronic device with an integrated light deflector comprises: a passive optical waveguide having a lower cladding layer, a core, and an upper cladding layer to guide and transmit optical signals; and a light deflector formed by patterning the upper cladding layer in a predetermined shape at an upper portion of the passive optical waveguide, wherein a refractive index of the core under the predetermined shape is modified to deflect a light beam by applying a current or an electrical field to the light deflector. According to the present invention, it is possible to provide an opto-electronic device with an integrated light deflector capable of deflecting the light propagation direction without necessity of a complicated external driving circuitry.

### BACKGROUND OF THE INVENTION

1. Field of the Invention

The present invention relates to an opto-electronic device with an integrated light deflector and an wavelength tunable external cavity laser using the opto-electronic device, and more particularly to an opto-electronic device with an integrated light deflector capable of changing a light propagation direction by forming a predetermined shape of component in an upper cladding at an upper portion of a passive optical waveguide, thereby applying a current or a voltage to modify a refractive index of the core and an wavelength tunable external cavity laser using the opto-electronic device.

2. Description of the Related Art

A light deflector capable of changing a light propagation direction is a device applicable to a variety of fields such as an optical data storage, a laser scanning, and an optical switch, and has been implemented by a polymer component capable of modifying a refractive index with respect to the light propagation direction or a component having a magneto-optical effect or an electro-optical effect.

However, devices having such components have been disadvantageous in that they must be large or complicated to deflect the light propagation direction and their responses are also late. Furthermore, materials needed to fabricate such devices have the unavoidable shortcoming that they can not be integrated with semiconductor materials such as InP used for the optical devices of a Wavelength Division Multiplexing (WDM).

Hereinafter, a semiconductor laser with an integrated light deflector for deflecting the light propagation direction according to related arts will be described with reference to attached drawings.

FIG. 1 is a block diagram showing a light deflector according to a related art disclosed in U.S. Pat. No. 4,872,746. Referring to FIG. 1, reference No. 101 indicates an acousto-optic element, No. 102 indicates a light beam incident to the acousto-optic element, No. 103 indicates a zero order diffraction of the light beam incident to the acousto-optic element, and No. 104 indicates the first order diffraction. The light beams are diffracted to different directions depending on variation of the frequency applied to the acousto-optic element.

A high frequency signal generated by a Voltage Controlled Oscillator (VCO) 106 passes through a modulator 107 capable of modulating the frequency and a power amplifier 108, and then is applied to the acousto-optic element 101. The output frequency of the VCO 106 is controlled by the voltage signal applied to an input terminal from a signal generator 109. Therefore, the output frequency can be changed by adjusting the input voltage, thus enabling a light beam deflection. In other words, the propagation direction of the light beam output from a light emitting source such as a laser is changed when passing through the acousto-optic material. The narrow slit shown in this structure is only for obtaining the first order diffraction light beam. In such a configuration of the light deflector, the propagation direction of the first order diffraction light beam can be deflected by adjusting frequency of the signal applied to the acousto-optic element. In such a configuration, since deflection efficiency is changed depending on the frequency of the excitation signal, the amplitude of the excitation signal is modulated in order to correct the deflection efficiency so that constant deflection efficiency can be ensured.

FIG. 2 is a block diagram of a deflector system according to another related art disclosed in U.S. Pat. No. 6,292,310, which propose a deflector system constructed only by lenses to change the light propagation direction. The basic light deflector 210 includes an initial dynamic light deflector 214 and a light deflection amplifier 216, thereby deflecting the light beam based on the classical geometric optics. When the light beam generated by the light emitting diode 218 passes through a typical optical system 220, the light beam is appropriately modified to meet the requirement of the initial dynamic light deflector 214. Reference No. 232 indicates an external device. In other words, in such a configuration, a lens system comprises a part of lenses for changing the light propagation direction initially in a narrow angle and the other part of lenses for amplifying the changes of the light propagation direction in a wider angle.

According to still another related art disclosed in U.S. Pat. No. 4,889,415, a deflector structure for deflecting the light propagation direction includes a piezo-electric crystal interposed between two lenses so that an acoustic wave is refracted when an excitation signal is applied to this crystal, whereby the incident light beam is emergent to different directions from an output lens depending on its frequency. This structure includes a part having a piezo-electric element for deflecting the light propagation direction and the other part having a deflection amplifier for amplifying the propagation direction of the deflected light beam in a wider angle. The collimated light beam generated by lenses in a light source passes through a first light deflector which is controlled by an external device, thereby having a narrow deflection angle. Then, the light beam passes through a deflection amplifier comprising classical geometric optical elements to amplify the deflection angle.

In addition, according to a related document disclosed in “Journal of Light Wave Technology, Vol. 12, pp.1401-1404” by Qibiao Chen et el., an electro-optic deflector using an acousto-optic effect is fabricated from LiTaO₃ so that the diffraction angle of the light beam is deflected depending on an input voltage. Furthermore, according to another related document disclosed in “IEEE Photonics Technology Letters, Vol. 13, pp.490-492” by Chiou-Hung Jang et el., voltages are applied to the polymer light deflector formed on a silicon substrate to deflect the direction of the emergent light beam. Still further, according to another document disclosed in “Electronics Letters, Vol. 34, pp.881-882” by K. Petroz et el., a light deflector has lenses and an electrostatic comb structure on a silicon substrate.

As described above, the technologies for deflecting the propagation direction of the light beam emergent from a laser diode or other kind of light source can be applied to a variety of fields such as an optical data storage, a laser scanning, and an optical switch. Functions required for such a variety of fields have been implemented by a polymer element for modifying a refractive index with respect to the light propagation direction, or an element having an electro-optic or magneto-optic effect.

Such conventional light deflectors have respective advantages in their organizations and performances. However, they also have disadvantages in that a complicated external driving circuitry is needed to drive the light deflector, the size of the module can not be minimized, or their response times are late. Furthermore, they can not be integrated with a semiconductor material such as an InP used for a WDM optical communication system.

### SUMMARY OF THE INVENTION

The present invention is contrived to solve the above problems and an object of the present invention is to provide an opto-electronic device with a novel type of integrated light deflector.

Another object of the present invention is to make it possible to integrate a light deflector with a semiconductor material such as an InP used for an optical communication system.

Still another object of the present invention is to provide a light source capable of changing the propagation direction of the emergent light beam by integrating a light deflector into a part of the passive optical waveguide composed of the same material as a semiconductor laser diode.

In order to accomplish the above objects, according to one aspect of the present invention, an opto-electronic device with an integrated light deflector comprises: a passive optical waveguide having a lower cladding layer, a core, and an upper cladding layer to guide and transmit optical signals; and a light deflector formed by patterning the upper cladding layer in a predetermined shape at an upper portion of the passive optical waveguide, wherein a refractive index of the core under the predetermined shape is modified to deflect a light beam by applying a current or an electrical field to the light deflector.

In addition, the predetermined shape is formed to make an angle of an emergent light beam different from that of an incident light beam. For example, the predetermined shape is a triangle or a trapezoid. Furthermore, the predetermined shape is patterned by an engraving or embossing method

Preferably, the light deflector is an array in which the predetermined shapes are repeatedly aligned, the array being an array having identical shapes, an array in which identical shapes have different incident angles of optical signals, or a combination thereof.

Still further, it is possible to integrate a semiconductor laser by further comprising an active area for generating an optical signal.

Meanwhile, the cladding areas of the passive optical waveguide can be composed of an InP material, and the core area and the active area are composed of an InGaAsP material.

According to another aspect of the present invention, an opto-electronic device with an integrated light deflector comprises: a passive optical waveguide having a lower cladding layer, a core, and an upper cladding layer to guide and transmit optical signals; and a light deflector having an electrode formed to have a predetermined shape by patterning at an upper portion of the upper cladding layer of the passive optical waveguide, wherein a refractive index of the core under the predetermined shape is modified to deflect a light beam propagation by applying a current or an electrical field to the light deflector.

According to still another aspect of the present invention, a wavelength tunable external cavity laser comprises: a light source with an integrated light deflector comprising a passive optical waveguide having a lower cladding layer, a core, and an upper cladding layer to guide and transmit optical signals, an active area for generating the optical signals, and the light deflector formed by patterning the upper cladding layer in a predetermined shape at an upper portion of a predetermined area of the passive optical waveguide; a collimator lens for collimating a light beam emergent from the light source; and a diffraction grating for changing a diffraction angle depending on a wavelength of the light beam through the collimator lens, wherein light beam propagation is deflected by modifying a refractive index of the core under the predetermined shape by applying a current or an electrical field to the light deflector.

Preferably, the wavelength tunable external cavity laser further comprises a reflecting mirror for reflecting a specific wavelength diffracted by the diffraction grating.

### BRIEF DESCRIPTION OF THE DRAWINGS

The aforementioned aspects and other features of the present invention will be explained in the following description, taken in conjunction with the accompanying drawings, wherein:

FIG. 1 is a block diagram illustrating a light deflector according to a related art disclosed in U.S. Pat. No. 4, 872,746;

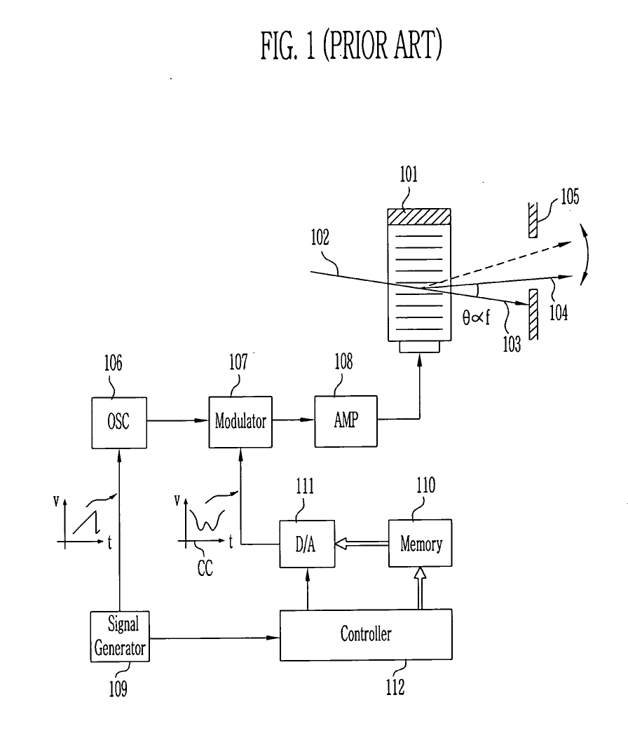

FIG. 2 is a block diagram illustrating a deflector system according to another related art disclosed in U.S. Pat. No, 6,292,310;

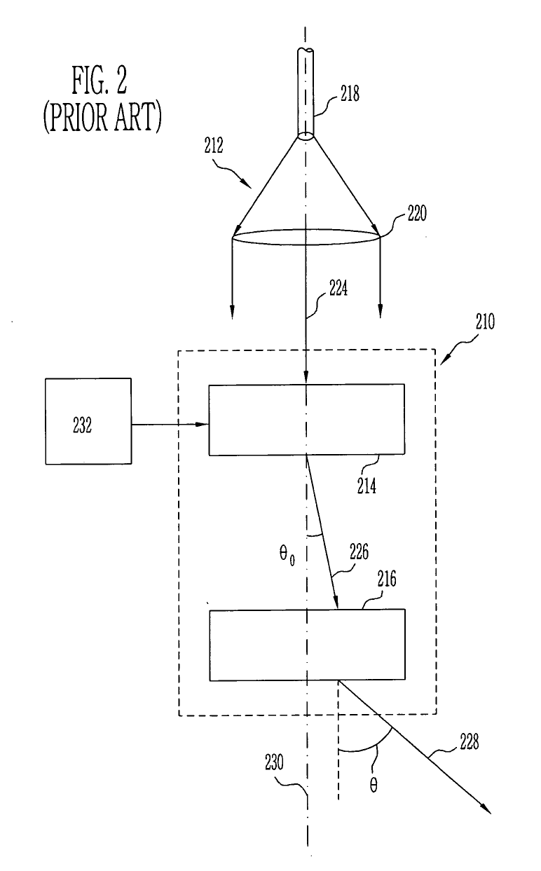

FIG. 3 is a plan view illustrating a passive optical waveguide with an integrated light deflector according to the preferred embodiment of the present invention;

FIG. 4 is a conceptual diagram for explaining the principle of light beam deflection by modeling a triangular shape of light deflector shown in FIG. 3;

FIG. 5 is a plan view illustrating a semiconductor laser in which a semiconductor light source and a light deflector capable of modifying its refractive index are integrated together according to the preferred embodiment of the present invention;

FIGS. 6 and 7 are schematic diagrams illustrating examples of an array including a triangular shape of light deflectors according to the preferred embodiments of the present invention;

FIG. 8 is a plan view and FIG. 9 is a cross sectional view, respectively, used for verifying the light deflection depending on the number of the deflectors and their intervals according to the preferred embodiment of the present invention;

FIGS. 10 to 12 are graphs illustrating results of the simulation used for showing variation of the propagation direction of the emergent light beam and their distribution at the same time depending on the number and the interval of a triangular shape of deflectors of which media have different refractive indices according to the preferred embodiment of the present invention;

FIGS. 13 and 14 are graphs showing variation of the light deflection angle depending on the number and the interval of a triangular shape of light deflectors of which media have different refractive indices according to the preferred embodiment of the present invention;

FIG. 15 is a graph illustrating deflection angles with respect to the current applied to a device which is fabricated according to the preferred embodiment of the present invention;

FIG. 16 illustrates an example of a Littman type wavelength tunable laser which is one of applications of an optical device with an integrated light deflector according to the present invention; and

FIG. 17 illustrates an example of a Littrow type wavelength tunable laser which is one of applications of an optical device with an integrated light deflector according to the present invention.

### DETAILED DESCRIPTION OF PREFERRED EMBODIMENTS

The present invention will be described in detail by way of the preferred embodiment with reference to the accompanying drawings, in which like reference numerals are used to identify the same or similar parts. Following embodiments shown in the drawings are intended to be not restrictive but illustrative of the present invention, and it would be appreciated a variety of modifications and changes can be adapted without departing from the scope and the spirit of appended claims.

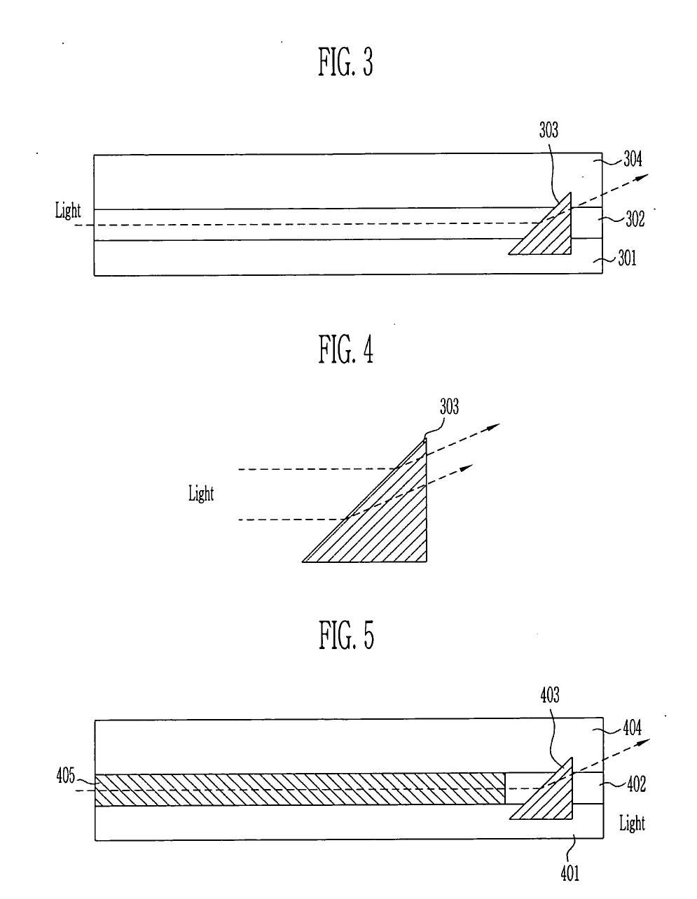

FIG. 3 is a cross-sectional view illustrating a passive optical waveguide with an integrated light deflector according to the preferred embodiment of the present invention.

The passive optical waveguide with an integrated light deflector shown in FIG. 3 includes cladding areas 301 and 304, an optical waveguide core 302, and a light deflector 303. The light beam guided by the optical waveguide core 302 is deflected when passing through the light deflector 303.

The light deflector 303 is formed by patterning a part of an upper cladding layer (not shown) in a predetermined shape at an upper portion of a predetermined area of the optical waveguide 302. The refractive index of the core under the predetermined shape is modified by applying a current or an electric field to the light deflector, thereby deflecting the light propagation direction. In other words, if the upper cladding layer is made of a p-type material and the core of the optical waveguide is made of an intrinsic material and the substrate is made of an n-type material, the predetermined shape may be formed at the p-i-n junction area, thereby making it easy to apply the current or the electric field. The portion of predetermined shape is connected to electrodes. Meanwhile, the predetermined shape may be patterned by a photolithography method. The predetermined shape of the light deflector is not limited to a shape by which an incident angle becomes different from an emergent angle, but a variety of shapes can be adapted. For example, the shapes include a triangle, a trapezoid, or any shape of polygons of which two sides are not parallel.

In another method of fabricating the light deflector 303, electrodes can be patterned to have a predetermined shape on the upper cladding layer. In this case, under the state that the upper cladding layer is not patterned, an electrode on the upper cladding layer is formed in a predetermined shape, whereby the refractive index of the core under the predetermined shape becomes different from that of the other portions.

On the other hand, one or more predetermined shapes may be formed into an array so that the light beam guided by the core 302 can be deflected by modifying the refractive index of the core 302. For example, the predetermined shape can be a triangle. For example, when the angle of the light beam incident to a triangular shape of light deflector becomes different from that of the emergent light beam, the core under the lower portion of the inside of the light deflector has a different refractive index from the core in the outside of the light deflector by applying a current or an electric field. As a result of such a configuration, the light propagation direction can be changed.

The light beam passing through the deflector 303 may be output without any changes of the deflection direction if the refractive index of the core 302 is the same as that of the passive optical waveguide. On the other hand, the deflection direction may be changed if the refractive index of the core is modified by applying the current or the electric field. Therefore, the emergent direction is changed depending on the variation of refractive index of the deflector, i.e., the strength of the applied electrical signal.

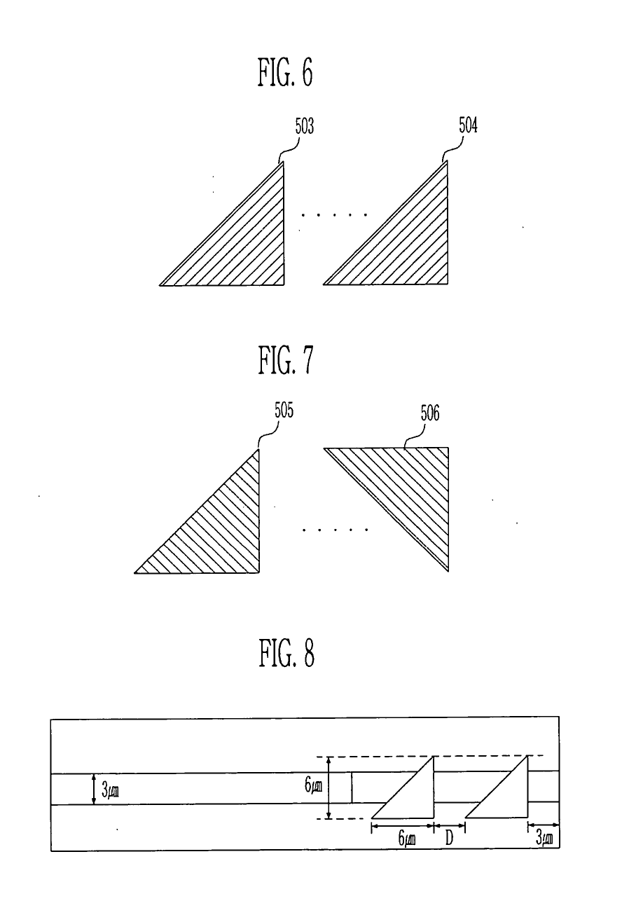

FIG. 4 is a conceptual diagram for explaining the principle that the light propagation direction is changed by modeling the light deflector 303 as a triangle. If a light deflector is formed to apply a current or an electric field to the triangular shape in the upper cladding layer above the core of the optical waveguide, and then the current or the electric field is substantially applied, the refractive index of the core of the optical waveguide is modified depending on the carrier concentration variation just in the portions of the triangular shapes. In other words, the light propagation can be deflected to a predetermined direction according to the principle that an emergent angle becomes different from the incident angle by the variation of refractive index.

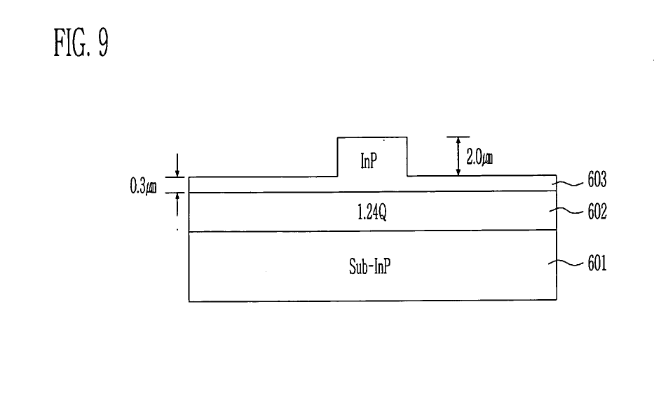

FIG. 5 is a plan view illustrating the structure of a light source capable of deflecting the emergent direction of the light beam by integrating a deflector structure capable of modifying the refractive index with a semiconductor light source. A structure in FIG. 3 shows a passive optical waveguide with an integrated light deflector. On the contrary, the other structure in FIG. 5 shows that a semiconductor laser is integrated into the passive optical waveguide with an integrated light deflector shown in FIG. 3.

The semiconductor laser with an integrated light deflector shown in FIG. 5 includes cladding areas 401, 404, a core of a passive optical waveguide 402, a light deflector 403, and an active area 405 of the optical waveguide for generating optical signals. The light beam generated in the active area 405 is guided to the core 402 of the passive optical waveguide and then passes through the deflector 403 to change its propagation direction. In other words, the light beam incident to the deflector 403 is output without deflecting its propagation direction when the refractive index of the core of the deflector 403 is the same as that of the core 402 of the passive optical waveguide. On the contrary, the propagation direction of the guided optical wave is deflected at the surface on which a refractive index is changed when refractive indices of the core of the deflectors 403 are different from that of the core 402 of the passive optical waveguide. At this point, the variation of emergent direction depends on the variation of refractive index of the core in the deflector 403.

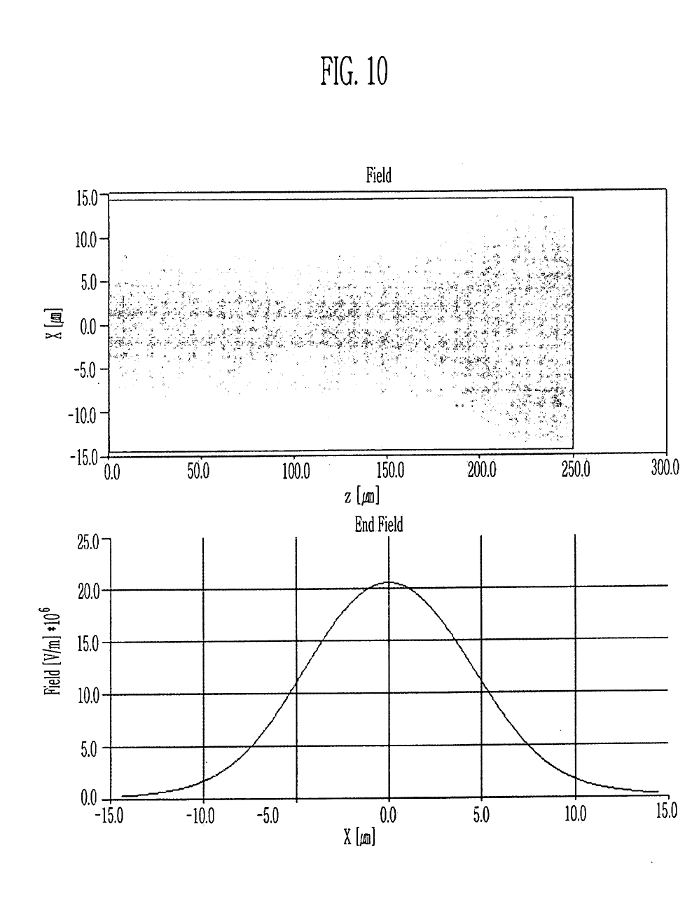

This type of deflector is required to have a sufficiently high refractive index variation in order to increase the magnitude of the deflection angle. However, the refractive index variation of the core is limited to be equal to or less than 0.05 due to the physical characteristics of the media including an InGaAsP. In order to overcome such a physical limitation, a variety of methods can be adapted. FIGS. 6 and 7 show that the triangular shape of deflectors are arranged in an array. Referring to FIG. 6, a triangular shape of deflectors are repeatedly arranged to form an array 503 to 504. Such a multi-stage arrangement of a triangular shape of reflectors results in a remarkable increase of the deflection angle. In other words, the light beam incident to the deflectors can be deflected in a wider angle because it undergoes the refractive index variation generated by applying electrical signals to the deflectors in a plurality of stages. The arrangement of a triangular shape of deflectors shown in FIG. 7 is different from that in FIG. 6 in which the deflectors are identically repeated. However, it would be apparent to those skilled in the art that a variety of modifications can be adapted and the present invention is not limited by the arrangements shown in FIGS. 6 and 7. The arrangement can be an array of identical shapes, an array in which every identical shapes are arranged to have different incident angles of optical signals, or a combination thereof. By such arrangements, the light deflection direction can be adjusted to be left or right with respect to the cross sectional surface of the semiconductor laser.

<Simulation>

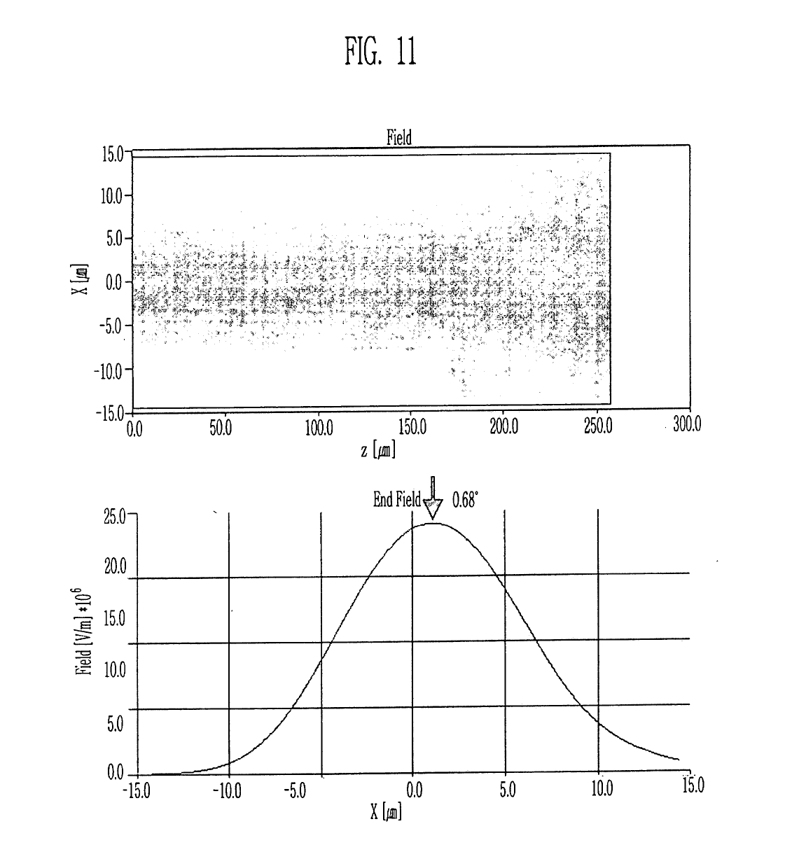

A simulation was accomplished for the deflection angle variation of the guided light beam according to the refractive index variation of the core of the deflector in a passive optical waveguide with an integrated deflector. Now, the results of the simulation will be described. FIGS. 8 is a plan view and FIG. 9 is a cross sectional view, respectively, used for the simulation of verifying the light beam deflection according to the number of the deflectors and their intervals.

Following descriptions are for main variables. used for the simulation for the above structure. The width of the ridge in the passive optical waveguide is set to 3 μm. For the shape of the light deflector, an isosceles right-angled triangle having a height of 6 μm and a bottom side of 6 μm is used. The interval between the triangular shapes is set to 3 μm. The length from the last triangular shape to the end side of the optical waveguide is set to 3 μm. A ridge structure is adapted for a light source, of which a height is set to 2 μm and a height of the cover layer is set to 0.3 μm, and the thickness of the band gap is set to 0.4 μm. Therefore, the band gap wavelength of the passive optical waveguide becomes 1.24 μm and the effective refractive index becomes 3.208.

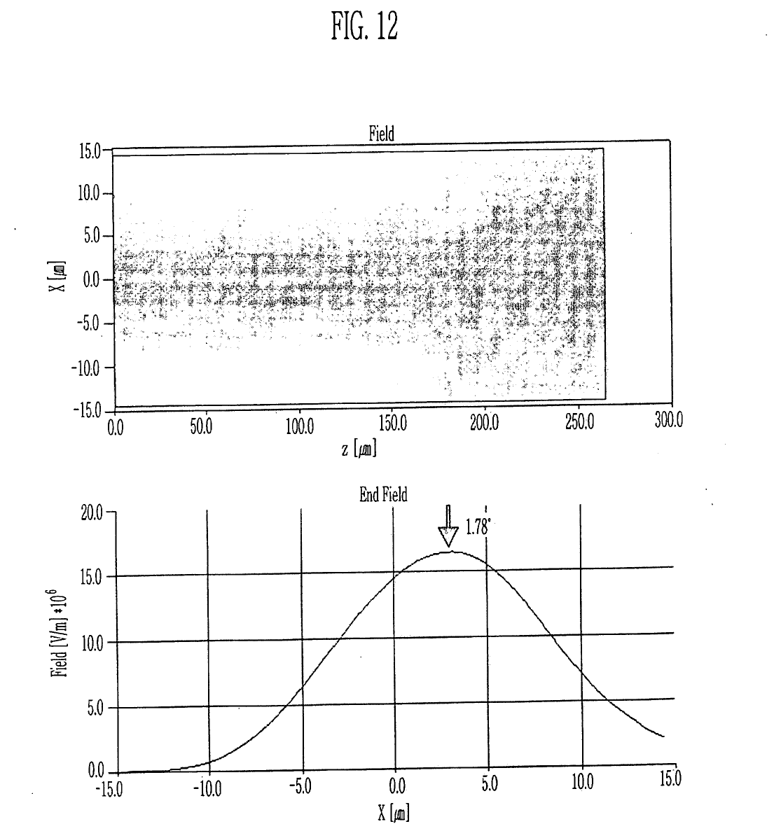

FIGS. 10 to 12 show results of the simulation using a BPM (Beam Propagation Method) for measuring the variation of propagation direction of the emergent light beam and their distributions at the same time according to the number and the interval of the triangular shapes integrated in the passive optical waveguide. They show the results when the number of the triangular shapes changes 0 to 2 under the condition of the above variables. In other words, FIG. 10 shows the variation of light propagation direction when no deflector is used, FIG. 11 shows that when one deflector is used, and FIG. 12 shows that when two deflectors are used.

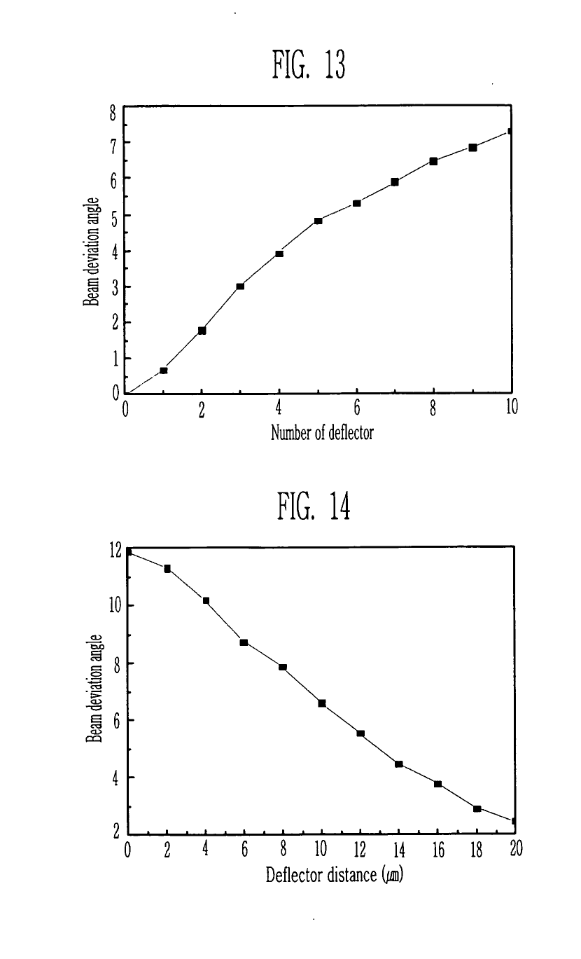

FIGS. 13 and 14 show the variation of light propagation direction according to the number and the interval of the triangular shapes formed in the passive optical waveguide. They show the results of the simulation for the deflection angle of the light beam when the number of the triangular shapes (deflectors) formed on the passive optical waveguide changes 0 to 10 and the interval of the triangular shapes changes 0 μm to 20 μm. Referring to FIG. 13, the light deflection angle also changes 0 to 8 degree as the number of deflectors increases 0 to 10. In addition, referring to FIG. 14, the deflection angle of the light beam changes 12 to 0 degree as the interval of the deflectors changes 0 to 20 μm.

<Example of Fabrication>

Meanwhile, an opto-electronic device in which a passive optical waveguide with an integrated light deflector is incorporated with a semiconductor laser was fabricated to measure deflection angles depending on a current applied. The device used for the measurement was fabricated in such a way that three triangular shapes (deflectors) are formed on the passive optical waveguide, each of triangles corresponds to an isosceles right-angled triangle having a bottom side of 20 μm and a height of 20 μm and the interval of the triangles is set to 10 μm. In addition, the core layer of the passive optical waveguide has the shape of a bulk made of an InGaAsP having a band gap of 1.24 μm. The upper cladding layer has a thickness of 0.3 μm and a height of the ridge was 1.8 μm. The upper cladding layer is partially removed to form the triangular shape.

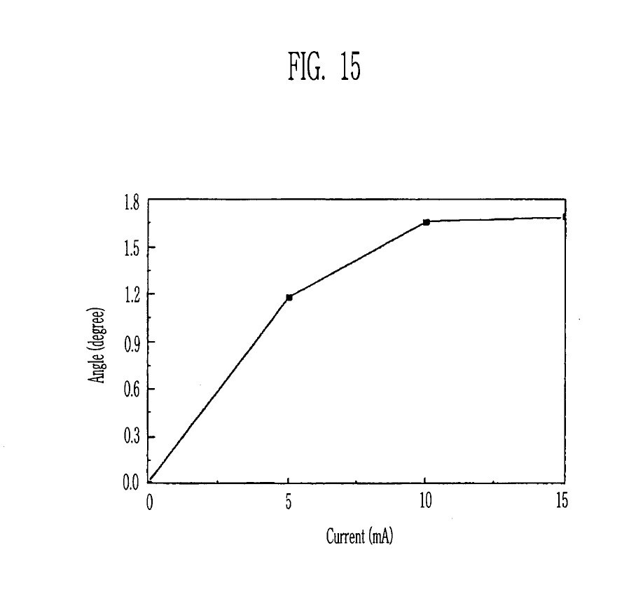

FIG. 15 is a graph illustrating deflection angles according to the current applied to the above example.

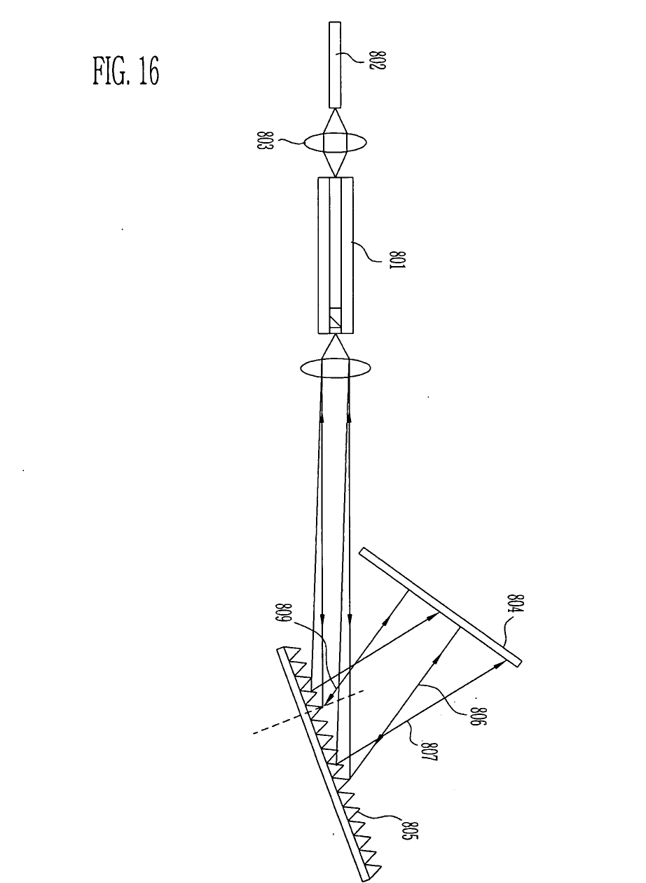

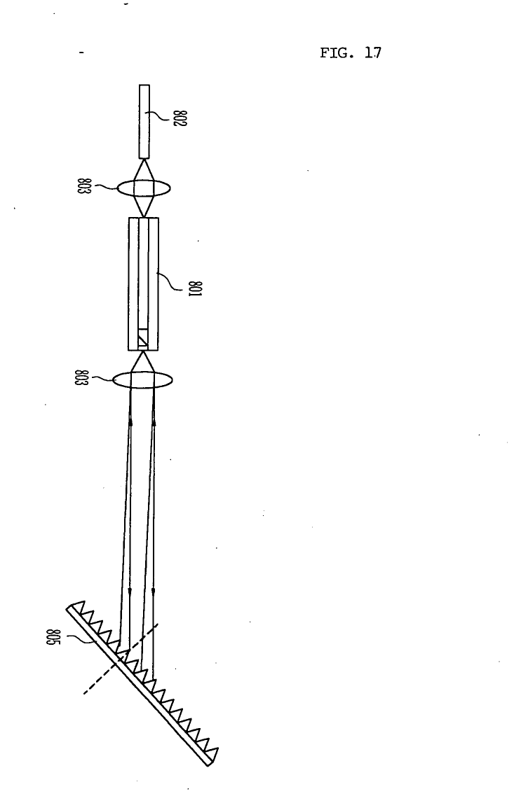

On the other hand, a semiconductor laser incorporating a passive optical waveguide with such an integrated light deflector is applicable to a light source of a wavelength tunable external cavity laser. FIG. 16 shows an example of a Littman type wavelength tunable laser which is one of applications of the semiconductor laser with an integrated light deflector according to the present invention. FIG. 17 shows an example of a Littrow type wavelength tunable laser which is one of applications of the semiconductor laser with an integrated deflector according to the present invention.

Referring to FIG. 16, a Littman type wavelength tunable external cavity laser comprises a light deflector 801 integrated with a light source, collimator lenses (803), a diffraction grating 805, and a reflecting mirror 804. The deflected light beam passes through the collimator lenses 803 and then is incident to the diffraction grating 805. The wavelength of the light beam perpendicularly incident to the reflecting mirror 804 is continuously adjustable by applying a voltages or a current to the deflector 801 so as to constitute an external cavity. The collimator lenses 803 make the light beam emergent from the light source be collimated. The diffraction grating 805 diffracts the light beam from the collimator lenses 803 with a different diffraction angle depending on its wavelength. The reflecting mirror 804 reflects a particular wavelength diffracted by the diffraction grating 805.

Referring to FIG. 17, a Littrow type external cavity wavelength tuner comprises a light deflector 801, collimator lenses 803, and a diffraction grating 805. The collimator lenses 803 make the light beam emergent from the light source be collimated, and then the light beams through the collimator lenses 803 have different diffraction angles depending on their wavelengths by the diffraction grating 805. In this case, the wavelength which makes the direction of the incident light beam be equal to the direction of diffracted light beam can be adjusted by modifying the refractive index of the deflector by applying electrical signals, thereby constituting an external cavity capable of continuously adjusting the wavelength of the light beam.

According to the above configuration, in an external cavity type light source comprising a diffraction grating and a reflecting mirror, it is possible to implement a light source capable of tuning the wavelength in a high speed by an electrical driving without mechanical rotation of reflecting mirrors or diffraction gratings.

According to the conventional light deflector, it has been necessary to have a large assembly or a complicated driving circuitry to deflect the light propagation direction. In addition, there have been several problems such as a slow response and difficulties in integrating with a semiconductor material like an InP material.

On the contrary, according to the present invention, it is possible to implement a light deflector integrated with a laser diode, wherein the deflector is made of the same material as the semiconductor laser and its refractive index is modified when a current or an electrical field is applied to a particular shape of portion in the passive optical waveguide in which the core has a high band gap so that the guided light beams are not absorbed. Therefore, it is possible to reduce a tuning speed which is determined by a carrier's life time to be equal to or lower than several nano-seconds, ensure a high reliability, minimize the size, and remarkably reduce the manufacturing cost.

The present invention has been described with reference to specific exemplary embodiments thereof. It will, however, be evident that various modifications and changes may be made thereto without departing from the broader scope and spirit of the invention as set forth in the appended claims. The specification and drawings are, accordingly, to be regarded in an illustrative rather than in a restrictive sense.

1. An opto-electronic device with an integrated light deflector, comprising:
a passive optical waveguide having a lower cladding layer, a core, and an upper cladding layer to guide and transmit optical signals; and
a light deflector formed by patterning the upper cladding layer in a predetermined shape at an upper portion of the passive optical waveguide,
wherein a refractive index of the core under the predetermined shape is modified to deflect a light beam by applying a current or an electrical field to the light deflector.

2. The opto-electronic device with an integrated light deflector according to claim 1, wherein the predetermined shape is formed to make an angle of an emergent light beam different from that of an incident light beam.

3. The opto-electronic device with an integrated light deflector according to claim 2, wherein the predetermined shape is a triangle or a trapezoid.

4. The opto-electronic device with an integrated light deflector according to claim 1, wherein the light deflector is an array in which the predetermined shapes are repeatedly aligned, the array being an array having identical shapes, an array in which identical shapes have different incident angles of optical signals, or a combination thereof.

5. The opto-electronic device with an integrated light deflector according to claim 1, wherein the opto-electronic device comprises an active area for generating the optical signals.

6. The opto-electronic device with an integrated light deflector according to claim 5, wherein the cladding areas of the passive optical waveguide are composed of an InP material, and the core area and the active area are composed of an InGaAsP material.

7. The opto-electronic device with an integrated light deflector according to claim 1, wherein the predetermined shape is patterned by an embossing or engraving method.

8. An opto-electronic device with an integrated light deflector, comprising:
a passive optical waveguide having a lower cladding layer, a core, and an upper cladding layer to guide and transmit optical signals; and
a light deflector having an electrode formed to have a predetermined shape by patterning at an upper portion of the upper cladding layer of the passive optical waveguide,
wherein a refractive index of the core under the predetermined shape is modified to deflect a light beam propagation by applying a current or an electrical field to the light deflector.

9. The opto-electronic device with an integrated light deflector according to claim 8, wherein the predetermined shape is formed to make an angle of an emergent light beam different from that of an incident light beam.

10. The opto-electronic device with an integrated light deflector according to claim 9, wherein the predetermined shape is a triangle or a trapezoid.

11. The opto-electronic device with an integrated light deflector according to claim 8, wherein the light deflector is an array in which the predetermined shapes are repeatedly aligned, the array being an array having identical shapes, an array in which identical shapes have different incident angles of optical signals, or a combination thereof.

12. The opto-electronic device with an integrated light deflector according to claim 8, wherein the opto-electronic device comprises an active area for generating the optical signals.

13. The opto-electronic device with an integrated light deflector according to claim 12, wherein the cladding areas of the passive optical waveguide are composed of an InP material, and the core area and the active area are composed of an InGaAsP material.

14. The opto-electronic device with an integrated light deflector according to claim 8, wherein the predetermined shape is patterned by an embossing or engraving method.

15. A wavelength tunable external cavity laser, comprising:
a light source with an integrated light deflector comprising a passive optical waveguide having a lower cladding layer, a core, and an upper cladding layer to guide and transmit optical signals, an active area for generating the optical signals, and the light deflector formed by patterning the upper cladding layer in a predetermined shape at an upper portion of a predetermined area of the passive optical waveguide;
a collimator lens for collimating a light beam emergent from the light source; and
a diffraction grating for changing a diffraction angle depending on a wavelength of the light beam through the collimator lens,
wherein the light beam propagation is deflected by modifying a refractive index of the core under the predetermined shape by applying a current or an electrical field to the light deflector.

16. The wavelength tunable external cavity laser according to claim 15, wherein the wavelength tunable external cavity laser further comprises a reflecting mirror for reflecting a specific wavelength diffracted by the diffraction grating.
